(19) United States
(12) Patent Application Publication
(10) Pub. No.: US 2020/0030705 A1
(43) Pub. Date: Jan. 30, 2020

(54) SYSTEM AND METHOD FOR DELIVERING WATER-RELATED SENSATIONS TO VIDEO VIEWERS

(71) Applicants: John Edward Aiken, Monroevile, PA (US); Joshua Roehrig, Greenock, PA (US)

(72) Inventors: John Edward Aiken, Monroevile, PA (US); Joshua Roehrig, Greenock, PA (US)

(21) Appl. No.: 16/521,588

(22) Filed: Jul. 24, 2019

Related U.S. Application Data
(60) Provisional application No. 62/702,873, filed on Jul. 24, 2018.

(51) Int. Cl. A63G 31/00; H04M 1/725; H04W 4/80; H04L 29/08; H04R 3/00

(52) U.S. Cl. CPC A63G 31/007; H04M 1/725; G06F 3/0482; H04L 67/141; H04R 3/00; H04W 4/80

(57) ABSTRACT

A system and method for timely delivery of water spray and/or drops to a video viewer's face, which includes an apparatus having a water-bottle attachment for creating pressure inside tubing to valves controlled by a CPU, and drip or spray nozzles attached to a headgear portion of the system and aimed to parts of the user's face. The CPU is triggered by timing relative to a distinct initiating sound from the video being watched to open and close valves at the appropriate time to coincide with events being viewed. Typically, a mobile wireless-connectable device will pick up the sounds with its microphone, correlate those with timing and events in a specific video, and send an appropriate signal to the CPU.

### CROSS REFERENCE TO RELATED APPLICATION

This patent application is related to and claims priority from U.S. Provisional Patent Application Ser. No. 62/702,873 filed Jul. 24, 2018.

### FIELD OF THE INVENTION

The present invention relates, in general, to multi-sensory entertainment and, more particularly, this invention relates to adding a water sensation to the sight and sound of conventional video viewing.

### BACKGROUND OF THE INVENTION

For decades, inventors have disclosed various means for adding senses other than sight and sound to the movie viewing experience. There have been many starting with Laube in U.S. Pat. No. 2,905,049 that have devised ways to add the sense of smell. Others such as Seiler in U.S. Pat. No. 8,644,967 have introduced other senses to the experience. Seiler in U.S. Pat. No. 9,402,133 discloses combining an audio output from a mobile device with vibratory output to various parts of the user's body. None appear to offer a tactile response geared strictly to water on the skin. There are many devices for spraying or blowing water onto one's skin, but synchronizing that with video content has not been disclosed.

### SUMMARY OF THE INVENTION

The present invention provides a system and method for timely delivery of water spray or drops to a video viewer's face, which includes an apparatus having a water-bottle attachment for creating pressure inside tubing to valves controlled by a control module, and drip or spray nozzles attached to a headgear portion of the system and aimed to parts of the user's face. The control module is triggered by a signals from a pre-programmed mobile device, such as an app on smart phone, to open and close valves at the appropriate time to coincide with events being viewed. Typically, the mobile device will pick up sounds with its microphone, correlate those with timing and events in a specific video, and send an appropriate signal at the appropriate time to the control module to open valves to drip or spray water intermittently.

In some embodiments, the smart phone acts as the control also. Additional sensory events can also be synchronized and delivered to one viewer at a time, such as wind and scents.

### OBJECTS OF THE INVENTION

It is, therefore, one of the primary objects of the present invention to provide a system and apparatus for synchronizing water delivery to the face of a viewer with events in a movie or video game.

Another object of the present invention is to provide a simple device attachable to a standard drinking water bottle so as to enable pressurized water to be delivered up a thin tube and onto a user's body in more than one location.

Still another object of the present invention is to provide a system and method adaptable to an advanced mobile device to accept input from a programmed code tailored to events and sounds in a specific video or video game.

Yet another object of the present invention is to provide a method by which an individual user can effectively engage with brief sensory happenings to enhance the video viewing experience.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures.

### BRIEF DESCRIPTION OF THE DRAWINGS

FIG. 1 provides a perspective schematic view of the water delivery system with a wind option.

FIG. 2 is a flow diagram of an exemplary method of deploying the present water delivery system with a mobile-phone receiving video-specific code translated to water spray activation.

FIG. 3 is an exemplary flow diagram for an alternative embodiment to generate pressurized water and synchronize its delivery to persons viewing video content.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, very similar components which have identical functions have been identified with identical reference numerals throughout the several views illustrated in the drawing figures.

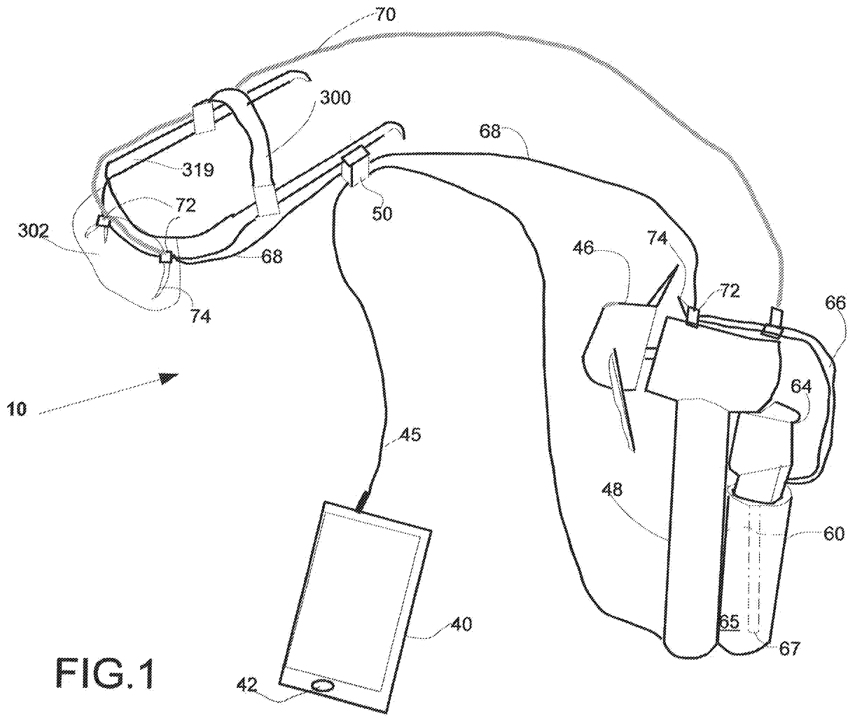

Referring initially to FIG. 1, the schematic view of the pressurized water apparatus and associated system 10 shows a standard disposable drinking water bottle 60 with a specialized cap assembly. The cap assembly further includes a flexible rubber pressurizing bulb or button 64 and a tube 62 with an airtight seal through the cap 62 and ending with a dip tube 67 extending to near the bottom of the bottle 60. The bulb or button 64 is much like that commonly found on spray bottles.

The water bottle assembly is part of a system 10 for delivering multiple sensory experiences to individuals viewing video content such as movies or games. The synchronization for each with what the viewer is seeing at the same time is preferably coordinated through a internet-connectable mobile device, such as a smart phone or tablet computer 40. In a preferred mode, the microphone 42 picks up a distinct audio signal from the entertainment being watched to initiate the time sequence that is then used to deliver the extra-sensory experiences at the appropriate time. This obviates the need for the viewer to precisely start the extra-sensory device programming in sync with the video. That timing sequence code is purchased from a provider that has programmed it according to video content and the apparatus available. The headframe 319 will typically include at least a polarizer lens 302. Generally, there will be an attached control module (CPU) 50 that interfaces between the mobile device 40, and the CPU via either a cable 45 from an accessory jack 44 or a wireless Bluetooth connection. The mobile device 40 contains the purchased code and timing sequence for a particular video content and sends signals to the CPU 50 to activate various devices. For example, in the case of the water sprays, wires 68 go out to micro-solenoid valves 72, which then open or close to release water according to what are happening in the video. If the scene has rain or spraying water on a speedboat, at least one spray nozzles 74 will send out a mist toward the viewer's face, preferably through the blades of fan 46. Or if someone is crying, just one valve 72 will open to drip water out a nozzle 70 behind the lens 302 onto the viewer's cheek. The CPU 50 can also function with other sensory devices such as scent delivery as described in companion applications, and a battery unit can power the instant invention and others as well.

Another sensory experience can be realized with an optional fan 46 connected to the mobile device 40 and aimed at the user's face. It is powered by batteries in compartment 48. There are many such devices already commercially available, but one that pivots up and down is preferable for obtaining and holding the desired angle. It would be turned off and on by the code in the mobile device synchronized to specific video events, be it movies or video games. Some possible video events would include walking on a beach, riding a bicycle, motorcycle, or in a boat or convertible. Another might be an approaching storm.

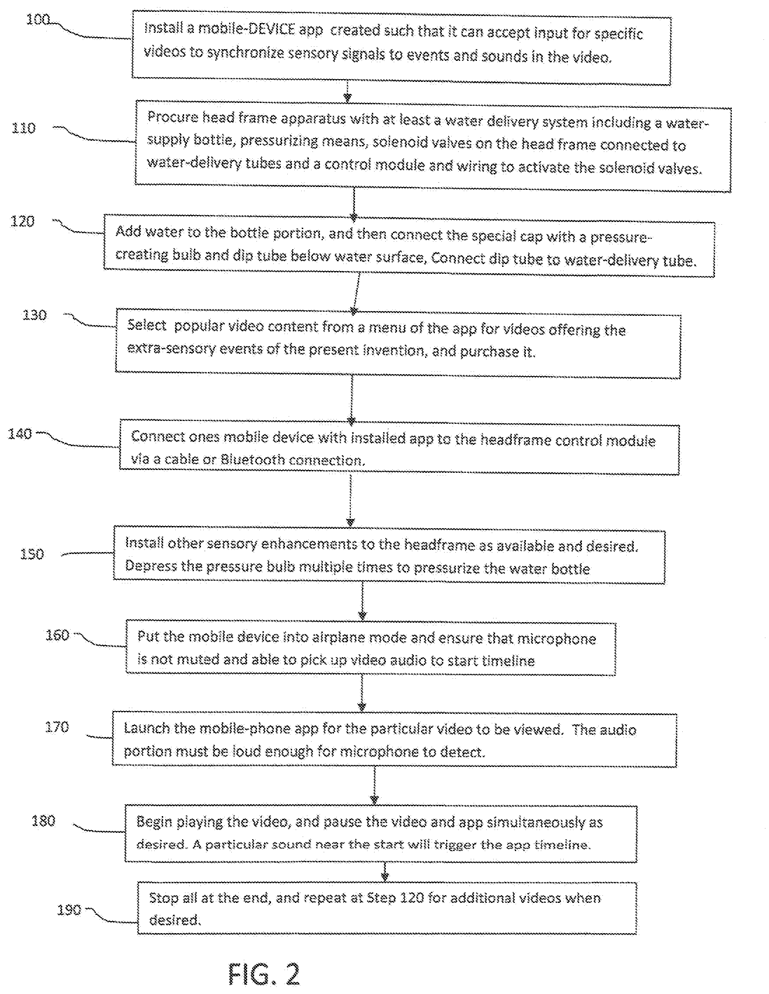

FIG. 2 is a flow diagram of an exemplary method of deploying the present water delivery system with a mobile-phone receiving video-specific code translated to water spray activation. These are instructions for the user primarily, but the developer has a role as well, particularly at steps 100 and 130. There are numerous variations of this method that can be devised and still be within the scope of FIG. 2.

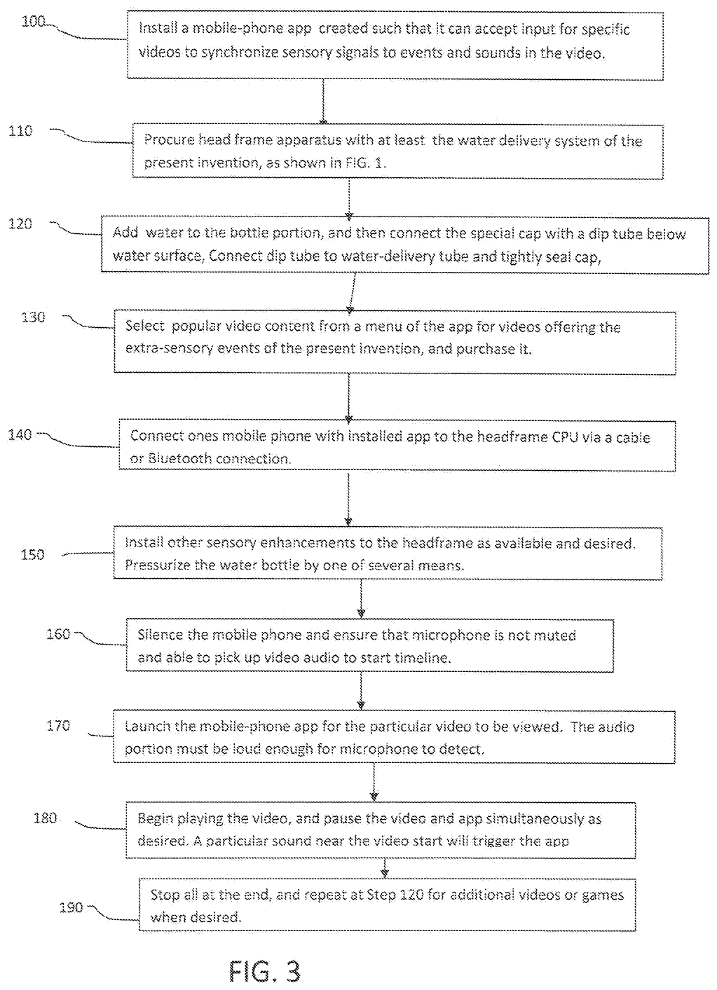

FIG. 3 is an exemplary flow diagram for an alternative embodiment of the present invention to generate pressurized water and synchronize its delivery to persons viewing video content including fan. Like that of FIG. 2, an apparatus for delivering brief pulses of water is controlled by code downloaded via a mobile device. That code is specific to each movie, video, or video game, and the user pays for each specific download.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from the spirit of the invention.

What is claimed is:

1. A system for delivering multi-sensory experiences to a viewer of video content comprising;
a) a smart mobile device with an application installed to enable importing code specific to a particular video content,
b) an apparatus including a reservoir for liquid configured to be pressurized and intermittently deliver said liquid to multiple locations on the face of the said viewer,
c) a means for pressuring said reservoir, and
d) a means for converting signals from said smart mobile device to actuate delivery of said liquid from said apparatus.

2. The system of claim 1 wherein said system apparatus The system of claim 1 wherein said means for pressurizing said reservoir is a finger-operated pump.

3. The system of claim 1 wherein said system apparatus configured for intermittent delivery includes at least two solenoid valves.

4. The system of claim 3 wherein said system further includes a head-mounting device.

5. The system of claim 3 wherein said system further includes a battery-operated fan.

6. The system of claim 4 wherein said battery-operated fan is configured to spray said liquid released from one of said at least two solenoid valves.

7. A method for delivering water sensations to video viewers comprising the steps of:
a) Install a mobile-device app created such that it can accept input for specific videos to synchronize sensory signals to events and sounds in the video.
b) Procure head frame apparatus with at least a water delivery system including a liquid-supply bottle, pressurizing means, solenoid valves on the head frame connected to water-delivery tubes and a control module and wiring to activate the solenoid valves.
c) Add water to the bottle portion, and then connect the special cap with a pressure-creating bulb and dip tube below water surface, then connect dip tube to water-delivery tube.
d) Select popular video content from a menu of the app for videos offering the extra-sensory events of the present invention, and purchase it.
e) Connect ones mobile device with installed app to the headframe control module via a cable or Bluetooth connection.
f) Connect ones mobile device with installed app to the headframe control module via a cable or Bluetooth connection.
g) Put the mobile device into airplane mode and ensure that microphone is not muted and able to pick up video audio to start timeline
h) Begin playing the video, and pause the video and app simultaneously as desired. A particular sound near the start will trigger the app timeline.
i) Begin playing the video, and pause the video and app simultaneously as desired. A particular sound near the start will trigger the app timeline.

8. A method for delivering water sensations to video viewers comprising the steps of:
a) Install a mobile-device app created such that it can accept input for specific videos to synchronize sensory signals to events and sounds in the video;
b) Procure head frame apparatus with at least the water delivery system of the present invention;
c) Select popular video content from a menu of the app for videos offering the extra-sensory events of the present invention, and purchase it.
d) Connect ones mobile device with installed app to the headframe CPU via a cable or Bluetooth connection.
e) Install other sensory enhancements to the headframe as available and desired. Depress the pressure pump multiple times to pressurize the water bottle.
f) Install other sensory enhancements to the headframe as available and desired. Depress the pressure pump multiple times to pressurize the water bottle
g) Launch the mobile-device app for the particular video to be viewed. The audio portion must be loud enough for microphone to detect.
h) Begin playing the video, and pause the video and app simultaneously as desired. A particular sound near the start will trigger the app timeline.
